(19) United States
(12) Patent Application Publication
(10) Pub. No.: US 2026/0248098 A1
(43) Pub. Date: Aug. 27, 2026

(54) PET FENCE

(71) Applicant: JIANGSU ZHONGHENG PET ARTICLES JOINT-STOCK CO., LTD., Yancheng City (CN)

(72) Inventor: Bin QIU, Yancheng City (CN)

(21) Appl. No.: 19/417,252

(22) Filed: Dec. 11, 2025

(30) Foreign Application Priority Data
Feb. 21, 2025 (CN) 202520281552.8

(51) Int. Cl. A01K 1/00; E04H 17/18

(52) U.S. Cl. CPC A01K 1/0035; E04H 17/185

(57) ABSTRACT

Provided is a pet fence, including: a plurality of fence sections connected end to end in sequence to form a fence body; connection assemblies, where each of the connection assemblies is arranged between two adjacent ones of the plurality of fence sections as well as in a respective one of the plurality of fence sections; an access opening provided on at least one of the plurality of fence sections; and a door rotatably connected to the access opening. Through the configuration of the foldable fence sections, the pet fence may be folded when not in use, so that storage space may be reduced and space utilization may be improved.

### CROSS REFERENCE TO THE RELATED APPLICATIONS

This application is based upon and claims priority to Chinese Patent Application No. 202520281552.8, filed on Feb. 21, 2025, the entire contents of which are incorporated herein by reference.

### TECHNICAL FIELD

The present disclosure relates to the field of pet products, and specifically to a pet fence.

### BACKGROUND

With the development of social economy and the acceleration of urbanization, urban families are becoming increasingly independent and individualized, and are facing an aging population, leading to a diversification of residents' leisure, consumption, and emotional needs. Accordingly, the spending budget on pets will also increase. Pet fences are essential for pets.

Although existing pet fences can basically meet people's needs, assembly is required after purchase. Such pet fences are generally fixed by screws or other means, and need to be assembled or disassembled using a special tool, which is quite troublesome. In addition, after a pet fence is assembled, it has a fixed structure that is difficult to move. For example, the pet fence is larger than a door of a room, and when the pet fence needs to be moved out of the room, the pet fence needs to be disassembled, moved out of the room, and then reassembled. The pet fence also needs to be disassembled for storage to reduce storage space and reassembled for use when needed. After the repeated assembly and disassembly of the pet fence, small parts such as screws are easily lost.

### SUMMARY

To solve the technical problem that existing pet fences require complex assembly and disassembly steps and parts of such pet fences are easily lost during movement, an objective of the present disclosure is to provide a pet fence.

To achieve the above objective, an embodiment of the present disclosure provides a pet fence, including:
a plurality of fence sections, where the plurality of fence sections are connected end to end in sequence to form a fence body;
connection assemblies, where each of the connection assemblies is arranged between two adjacent ones of the plurality of fence sections as well as in a respective one of the plurality of fence sections;
an access opening, where the access opening is provided on at least one of the plurality of fence sections; and
a door, where the door is rotatably connected to the access opening.

In the above technical solution, the plurality of fence sections respectively include:
first fence frames;
first fence panels, where the first fence panels are respectively connected within the first fence frames;
second fence frames, where an end of each of the second fence frames is connected to an end of a respective one of the first fence frames; and
second fence panels, where the second fence panels are respectively connected within the second fence frames.

In the above technical solution, the first fence frames in the plurality of fence sections are connected end to end in sequence; and
the second fence frames in the plurality of fence sections are connected end to end in sequence.

In the above technical solution, the pet fence further includes:
fixing members, where each of the fixing members is arranged between two adjacent ones of the plurality of fence sections, a plurality of first limiting grooves are provided on a side of each of the fixing members and are circumferentially arranged around a center of the side of each of the fixing members, and the plurality of first limiting grooves are connected to an edge of each of the fixing members.

In the above technical solution, a plurality of second limiting grooves are provided on the side of each of the fixing members adjacent to the plurality of first limiting grooves.

In the above technical solution, each of the connection assemblies includes:
a first connecting sleeve, where the first connecting sleeve is arranged between two adjacent ones of the first fence frames, and adjacent ends of the two adjacent ones of the first fence frames are rotatably connected in the first connecting sleeve;
a second connecting sleeve, where the second connecting sleeve is arranged between two adjacent ones of the second fence frames, and adjacent ends of the two adjacent ones of the second fence frames are rotatably connected in the second connecting sleeve; and
a third connecting sleeve, where the third connecting sleeve is arranged between a respective one of the first fence frames and an adjacent one of the second fence frames, and adjacent ends of the respective one of the first fence frames and the adjacent one of the second fence frames are rotatably connected in the third connecting sleeve.

In the above technical solution, each of the first fence panels and the second fence panel is a mesh panel.

Additional aspects and advantages of the present disclosure will be apparent from the description below, or understood through practice of the present disclosure.

### BRIEF DESCRIPTION OF THE DRAWINGS

The above and/or other additional aspects and advantages of the present disclosure will become apparent and comprehensible from the description of embodiments made in connection with the accompanying drawings, in which:

FIG. 1 is an overall schematic structural view of the present disclosure.

FIG. 2 is a schematic structural view of two fence sections that are connected according to the present disclosure.

FIG. 3 is a schematic structural enlarged view of part A of the present disclosure.

FIG. 4 is a schematic structural enlarged view of part B of the present disclosure.

FIG. 5 is a schematic structural enlarged view of part C of the present disclosure.

FIG. 6 is a schematic structural view of a fixing member of the present disclosure.

FIG. 7 is a schematic structural view of the present disclosure in a folded state.

FIG. 8 is a schematic structural view of the present disclosure in a horizontally unfolded state.

FIG. 9 is a schematic structural view of the present disclosure in a vertically unfolded state.

### DETAILED DESCRIPTION OF THE EMBODIMENTS

To make the objectives, features, and advantages of the present disclosure more comprehensible, the present disclosure will be described in detail below with reference to the accompanying drawings and specific embodiments. It should be noted that the embodiments of the present disclosure and the features in the embodiments may be combined with each other without conflict.

Many specific details are set forth in the following description to provide a full understanding of the present disclosure. However, the present disclosure can also be implemented in other ways different from those described herein, so the scope of protection of the present disclosure is not limited by the specific embodiments disclosed below.

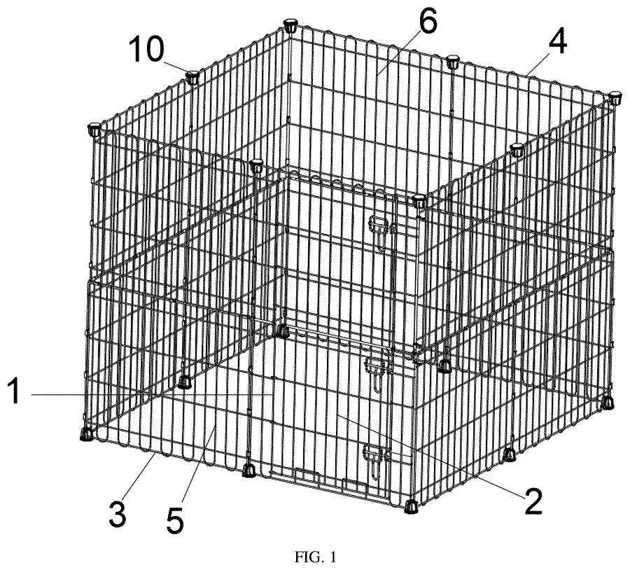

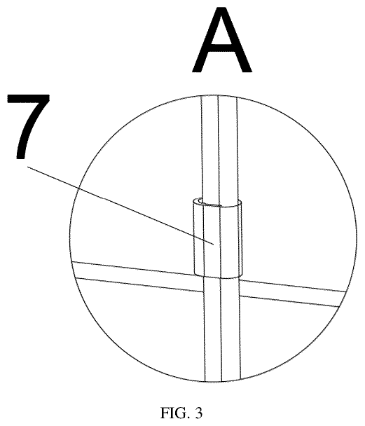

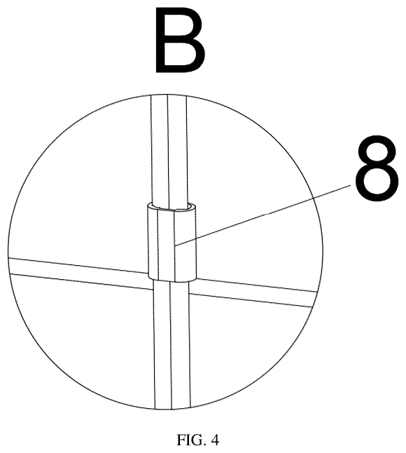

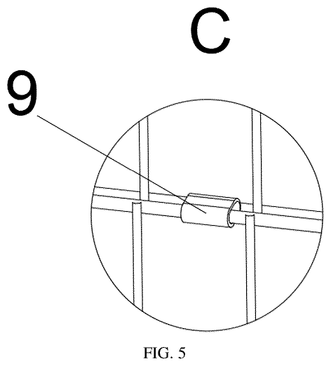

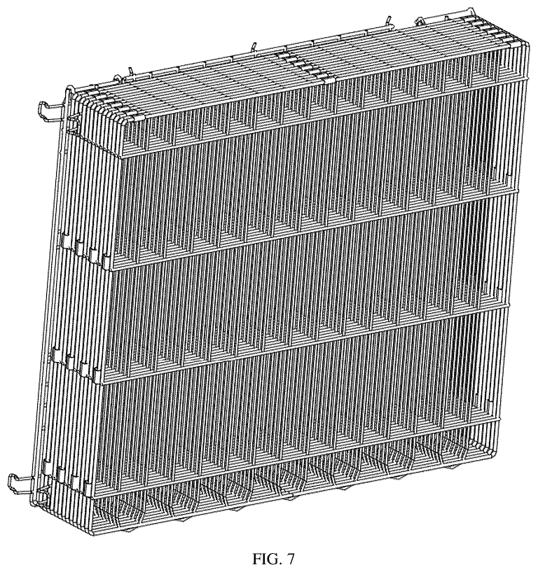

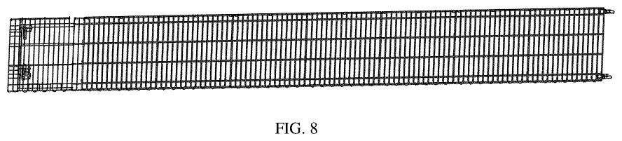

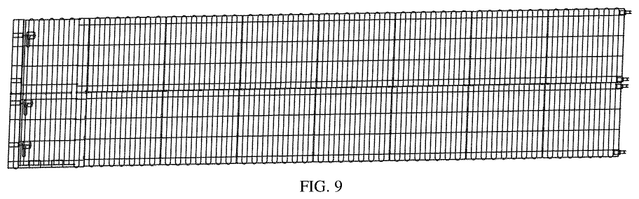

Some embodiments of a pet fence of the present disclosure will be described below with reference to FIG. 1 to FIG. 9.

As shown in FIG. 1 to FIG. 9, an embodiment of the present disclosure provides a pet fence, including:
a plurality of fence sections, where the plurality of fence sections are connected end to end in sequence to form a fence body;
connection assemblies, where each of the connection assemblies is arranged between two adjacent ones of the plurality of fence sections as well as in a respective one of the plurality of fence sections;
an access opening 1, where the access opening 1 is provided on at least one of the plurality of fence sections; and
a door 2, where the door 2 is rotatably connected to the access opening 1.

Before the fence body is mounted, the fence body is in a folded state and resembles a cuboid structure, so that storage space can be reduced and space utilization can be improved. In this case, the plurality of fence sections are folded together, and every two adjacent fence sections are connected by the connection assembly to prevent the plurality of fence sections from slipping to the ground one by one when inclined. The connection assembly provides a limiting effect, improving the stability of the fence sections after being folded.

To mount the fence body, two ends of the fence body are pulled away from each other along a horizontal direction to unfold the fence body, so that the fence sections enter a horizontally unfolded state. Then, a part of each of the fence sections is unfolded upward, and then the fence sections at the two ends are connected together, so that the fence body enters a fully unfolded state.

The above process does not require the use of screws or other parts to mount every two adjacent fence sections, and a user only needs to stretch the fence body in the folded state along the horizontal direction, unfold the fence sections upward, and connect the fence sections at the two ends. As such, mounting steps are simplified, and the time required for mounting the fence body is greatly reduced, so that the mounting efficiency is improved.

As shown in FIG. 1 to FIG. 9, in an embodiment of the present disclosure,
the plurality of fence sections respectively include:
first fence frames 3 each of a rectangular shape;
first fence panels 5, where the first fence panels 5 are fixedly connected within the first fence frames 3 respectively, and each of the first fence panels 5 is a mesh panel formed by metal wires;
second fence frames 4 each of a rectangular shape, where a lower end of each of the second fence frames 4 is arranged opposite to an upper end of a respective one of the first fence frames 3, and the description of orientations such as the lower end of each of the second fence frames 4 and the upper end of the respective one of the first fence frames 3 is merely for the fence body that has been fully unfolded and mounted; and
second fence panels 6, where the second fence panels 6 are fixedly connected within the second fence frames 4 respectively, and each of the second fence panels 6 is a mesh panel formed by metal wires.

The first fence frames 3 in the plurality of fence sections are connected end to end in sequence.

The second fence frames 4 in the plurality of fence sections are connected end to end in sequence.

Each of the connection assemblies includes:
a first connecting sleeve 7, where the first connecting sleeve 7 is arranged between two adjacent ones of the first fence frames 3, and adjacent ends of the two adjacent ones of the first fence frames 3 are rotatably connected in the first connecting sleeve 7, and the adjacent ends of the two adjacent ones of the first fence frames 3 are a head end of one of the two adjacent ones of the first fence frames 3 and a tail end of the other of the two adjacent ones of the first fence frames 3;
a second connecting sleeve 8, where the second connecting sleeve 8 is arranged between two adjacent ones of the second fence frames 4, and adjacent ends of the two adjacent ones of the second fence frames 4 are rotatably connected in the second connecting sleeve 8, and the adjacent ends of the two adjacent ones of the second fence frames 4 are a head end of one of the two adjacent ones of the second fence frames 4 and a tail end of the other of the two adjacent ones of the second fence frames 4; and
a third connecting sleeve 9, where the third connecting sleeve 9 is arranged between a respective one of the first fence frames 3 and an adjacent one of the second fence frames 4, and adjacent ends of the respective one of the first fence frames 3 and the adjacent one of the second fence frames 4 are rotatably connected in the third connecting sleeve 9, the adjacent ends of the respective one of the first fence frames 3 and the adjacent one of the second fence frames 4 are the upper end of the respective one of the first fence frames 3 and the lower end of the adjacent one of the second fence frames 4, and the upper end of the respective one of the first fence frames 3 and the lower end of the adjacent one of the second fence frames 4 are merely used for describing a positional relationship after the mounting of the fence body is completed.

For example, the pet fence of the present disclosure includes eight fence sections. Before the fence body of the pet fence is mounted, the eight fence sections are folded together to form a cuboid structure, which is convenient for storage and transportation, occupies small space, and greatly improves space utilization.

To unfold the fence body, the fence body in the folded state is first placed on the ground, so that the eight fence sections are arranged in sequence along the horizontal direction, and the eight fence sections are all in an upright state. In this case, because the first fence frame 3 and the second fence frame 4 in each fence section are in a folded state, the first fence frames 3 and the second fence frames 4 in the eight fence sections are also in an upright state, and the first fence frame 3 and the second fence frame 4 in each fence section are opposite to each other. Then, the fence sections at the two ends are pulled away from each other.

For example, the eight fence sections include a #1 fence section, a #2 fence section, a #3 fence section, a #4 fence section, a #5 fence section, a #6 fence section, a #7 fence section, and a #8 fence section. The first fence frames 3 in the #1 fence section, the #2 fence section, the #3 fence section, the #4 fence section, the #5 fence section, the #6 fence section, the #7 fence section, and the #8 fence sections are respectively a #1 first fence frame 3, a #2 first fence frame 3, a #3 first fence frame 3, a #4 first fence frame 3, a #5 first fence frame 3, a #6 first fence frame 3, a #7 first fence frame 3, and a #8 first fence frame 3. Three first connecting sleeves 7 are arranged between a head end of the #1 first fence frame 3 and a tail end of the #2 second first fence frame 3, and the head end of the #1 first fence frame 3 and the tail end of the #2 second first fence frame 3 run through the three first connecting sleeves 7, so that the head end of the #1 first fence frame 3 and the tail end of the #2 second first fence frame 3 are rotatable in the three first connecting sleeves 7, but the first connecting sleeves 7 are tightly sleeved over the head end of the #1 first fence frame 3 and the tail end of the #2 second first fence frame 3, to prevent the first connecting sleeves 7 from sliding freely by friction. Three first connecting sleeves 7 are arranged between a head end of the #2 first fence frame 3 and a tail end of the #3 second first fence frame 3, and the head end of the #2 first fence frame 3 and the tail end of the #3 second first fence frame 3 run through the three first connecting sleeves 7, so that the head end of the #2 first fence frame 3 and the tail end of the #3 second first fence frame 3 are rotatable in the three first connecting sleeves 7. Similar operations are performed, until a head end of the #7 first fence frame 3 is connected to a tail end of the #8 first fence frame 3.

Because the connection mode of two adjacent second fence frames 4 is the same as the connection mode of two adjacent first fence frames 3, the principle of the connection mode of two adjacent second fence frames 4 will not be described in detail herein.

Because the connection mode of the first fence frame 3 and the second fence frame 4 in each fence section is the same as the connection mode of two adjacent first fence frames 3, the principle of the connection mode of the first fence frame 3 and the second fence frame 4 in each fence section will not be described in detail herein.

It should be noted that when the fence body is in the folded state, a tail end of the #1 first fence frame 3 and a head end of the #8 first fence frame 3 are not connected, and when the fence body is in the fully unfolded state, the head end of the #1 first fence frame 3 and the tail end of the #8 first fence frame 3 are connected by a locking member. When the fence body is in the folded state, a tail end of the #1 second fence frame 4 and a head end of the #8 second fence frame 4 are not connected, and when the fence body is in the fully unfolded state, a head end of the #1 second fence frame 4 and a tail end of the #8 second fence frame 4 are connected by a locking member. The locking member belongs to the prior art and therefore will not be described in detail herein.

After the #1 fence section and the #8 fence section are pulled, the head end and the tail end of each first fence frame 3 are respectively rotated in the corresponding first connecting sleeve 7, and the head end and the tail end of each second fence frame 4 are respectively rotated in the corresponding second connecting sleeve 8, until the eight first fence frames 3 are on the same straight line, and the eight second fence frames 4 are also on the same straight line. In this case, the first fence frame 3 and the second fence frame 4 in each fence section are opposite to each other. Then, the second fence frames 4 are unfolded upward to cause the second fence frames 4 to rotate along the respective third connecting sleeves 9, until the second fence frames 4 have completely moved to the upper ends of the first fence frames 3 respectively, and the first fence frame 3 and the second fence frame 4 in each fence section are on the same vertical line.

Then, the #1 fence section and the #8 fence section are pulled, and the tail end of the #1 fence section is connected to the head end of the #8 fence section by using a locking member. Thus, the eight fence sections form the fence body. Because the access opening 1 is provided in the #1 fence section, an upper end of the access opening 1 is even with an upper end of the second fence frame 4 in the #1 fence section, and a lower end of the access opening 1 is even with a lower end of the first fence frame 3 in the #1 fence section, the access opening 1 is in an open state in a vertical direction. The open state means that the upper end and the lower end of the access opening 1 are free of any obstruction. One end of the door 2 is rotatably connected to an end of the access opening 1 away from the #8 fence section, and a door lock is provided at an other end of the door 2. After the door 2 is closed, the door lock can fix the door 2 to the #1 fence section, thus fixing the entire fence body. Thus, the mounting of the fence body is completed.

To fold the fence body, the door lock may be unlocked, the eight fence sections may be straightened, the second fence frames 4 may be flipped downward, and then the eight fence sections may be folded to form a cuboid block.

It should be noted that in the process of unfolding and folding the door 2, the principle of unfolding and folding the door 2 is the same as that of the first fence frame 3 and the second fence frame 4 in each fence section, so the details will not be repeated herein.

The above mounting process only requires pulling the fence sections at the two ends, unfolding the second fence frames 4 upward, and fixing the door 2 with the door lock. Therefore, the mounting process is simple and convenient. In addition, the first connecting sleeves 7, the second connecting sleeves 8, and the third connecting sleeves 9 have a simple structure and can be manufactured at low costs.

After the fence body is folded, storage space required can be greatly reduced and the space utilization can be improved.

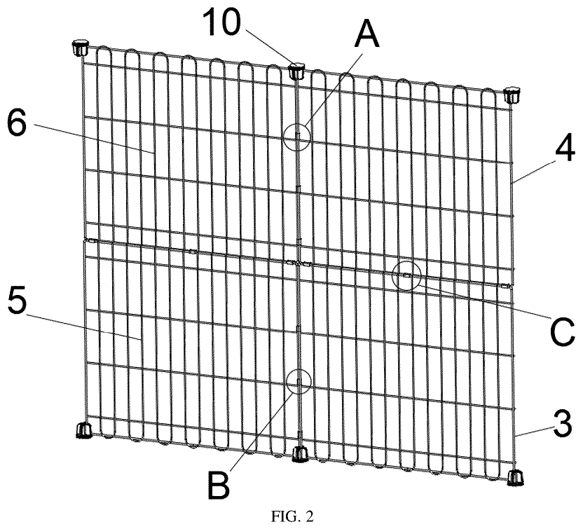

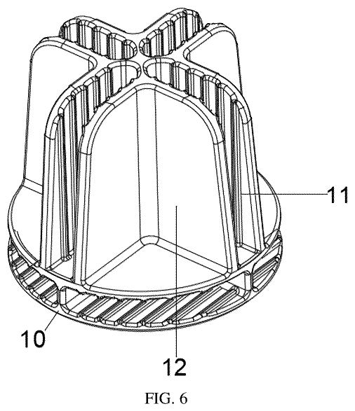

As shown in FIG. 1, FIG. 2, and FIG. 6, in an embodiment of the present disclosure, the pet fence further includes:
fixing members 10, where each of the fixing members 10 is arranged between two adjacent ones of the plurality of fence sections, a plurality of first limiting grooves 11 are provided on a side of each of the fixing members 10 and are circumferentially arranged around a center of the side of each of the fixing members 10, and the plurality of first limiting grooves 11 are connected to an edge of each of the fixing members 10.

Each of the fixing members 10 is cylindrical. A plurality of first limiting grooves 11 are provided on one of bottom surfaces of each of the fixing members 10. The plurality of first limiting grooves 11 are circumferentially arranged around a center of the bottom surface. The first limiting grooves 11 are connected to an edge of each of the fixing members 10. In the present disclosure, for example, four first limiting grooves 11 are provided, and every two adjacent first limiting grooves 11 are at an identical distance from each other. Therefore, an angle between a line connecting a center of one of two adjacent first limiting grooves 11 to the center of the bottom surface and a line connecting a center of the other one of the two adjacent first limiting grooves 11 to the center of the bottom surface is 90 degrees. When an angle between two adjacent fence sections needs to be designed to 90 degrees, a fixing member 10 may be placed at lower ends of two adjacent first fence frames 3, and then the lower ends of the two adjacent first fence frames 3 are respectively inserted into two adjacent first limiting grooves 11, so that the positions of the first fence frames 3 are fixed by the first limiting grooves 11. A fixing member 10 is placed at upper ends of two adjacent second fence frames 4, and the positions of the two adjacent second fence frames 4 are fixed using the same principle. As such, the angle between the two adjacent fence sections is 90 degrees, and the fence sections are prevented from deviating. When an angle between the two adjacent fence sections needs to be designed to 180 degrees, lower ends of two adjacent first fence frames 3 may be respectively inserted into first limiting grooves 11 that are opposite to each other, and upper ends of two adjacent second fence frames 4 may be respectively inserted into first limiting grooves 11 that are opposite to each other, so that the positions of the two adjacent fence sections can be fixed. As such, the angle between the two adjacent fence sections is set to 180 degrees.

It should be noted that two, three, five, or other numbers of first limiting grooves 11 may be provided on the bottom surface of the fixing member 10, and the principle of such cases is the same as the principle of the case where four first limiting grooves 11 are provided in this embodiment, so the details will not be repeated herein. The first limiting grooves 11 are respectively in tight contact with the first fence frames 3 and the second fence frames 4 to prevent the fixing members from falling off.

As shown in FIG. 6, in an embodiment of the present disclosure, a plurality of second limiting grooves 12 are provided on the side of each of the fixing members 10 adjacent to the plurality of first limiting grooves 11.

The plurality of second limiting grooves 12 are provided on the side of the fixing member 10 adjacent to the plurality of first limiting grooves 11, and each of the plurality of second limiting grooves 12 is provided between two adjacent ones of the plurality of first limiting grooves 11. Through the arrangement of the plurality of second limiting grooves 12, the material required for manufacturing the fixing member 10 may be reduced, thereby reducing the costs.

The present disclosure has the following advantages.
1. Through the configuration of the foldable fence sections, the pet fence may be folded when not in use, so that storage space may be reduced and space utilization may be improved.
2. Through the arrangement of each connection assembly between two adjacent ones of the plurality of fence sections as well as in a respective one of the plurality of fence sections, the connection assemblies allow for the folding and unfolding of the fence body of the pet fence, and every two adjacent fence sections may be connected without using other parts, so that the mounting efficiency is greatly improved.
3. The connection assembly has a simple structure and may be manufactured at low costs.

In the present disclosure, the terms such as “mount”, “connect”, “couple”, “fix”, and variants thereof should be interpreted in a broad sense. For example, “connection” may be a fixed connection, a detachable connection, or an integral connection; and “connection” may also be a direct connection or an indirect connection through an intermediate medium. For those of ordinary skill in the art, the specific meanings of the above terms in the present disclosure can be understood according to specific circumstances.

In the description of the present disclosure, it should be understood that the orientation or positional relationships indicated by the terms such as “inner” and “outer” are based on orientation or position relationships shown in the accompanying drawings, and are used only for ease and brevity of illustration and description, rather than indicating or implying that the mentioned apparatus or unit must have a particular orientation or must be constructed and operated in a particular orientation. Therefore, such terms should not be construed as limiting of the present disclosure.

In the description of this specification, the description with reference to the terms such as “an embodiment”, “some embodiments”, and “specific embodiment” means that specific features, structures, materials, or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments or examples.

The above description is merely preferred embodiments of the present disclosure, and is not intended to limit the present disclosure. To those skilled in the art, various modifications and variations may be made to the present disclosure. Any modification, equivalent replacement, or improvement made without departing from the spirit and principle of the present disclosure shall fall within the scope of protection of the present disclosure.

What is claimed is:

1. A pet fence, comprising:
a plurality of fence sections, wherein the plurality of fence sections are connected end to end in sequence to form a fence body;
connection assemblies, wherein each of the connection assemblies is arranged between two adjacent ones of the plurality of fence sections as well as in a respective one of the plurality of fence sections;
an access opening, wherein the access opening is provided on at least one of the plurality of fence sections; and
a door, wherein the door is rotatably connected to the access opening.

2. The pet fence according to claim 1, wherein
the plurality of fence sections respectively comprise:
first fence frames;
first fence panels, wherein the first fence panels are respectively connected within the first fence frames;
second fence frames, wherein an end of each of the second fence frames is connected to an end of a respective one of the first fence frames; and
second fence panels, wherein the second fence panels are respectively connected within the second fence frames.

3. The pet fence according to claim 2, wherein
the first fence frames in the plurality of fence sections are connected end to end in sequence; and
the second fence frames in the plurality of fence sections are connected end to end in sequence.

4. The pet fence according to claim 2, further comprising:
fixing members, wherein each of the fixing members is arranged between two adjacent ones of the plurality of fence sections, a plurality of first limiting grooves are provided on a side of each of the fixing members and are circumferentially arranged around a center of the side of each of the fixing members, and the plurality of first limiting grooves are connected to an edge of each of the fixing members.

5. The pet fence according to claim 4, wherein
a plurality of second limiting grooves are provided on the side of each of the fixing members adjacent to the plurality of first limiting grooves.

6. The pet fence according to claim 2, wherein
each of the connection assemblies comprises:
a first connecting sleeve, wherein the first connecting sleeve is arranged between two adjacent ones of the first fence frames, and adjacent ends of the two adjacent ones of the first fence frames are rotatably connected in the first connecting sleeve;
a second connecting sleeve, wherein the second connecting sleeve is arranged between two adjacent ones of the second fence frames, and adjacent ends of the two adjacent ones of the second fence frames are rotatably connected in the second connecting sleeve; and
a third connecting sleeve, wherein the third connecting sleeve is arranged between a respective one of the first fence frames and an adjacent one of the second fence frames, and adjacent ends of the respective one of the first fence frames and the adjacent one of the second fence frames are rotatably connected in the third connecting sleeve.

7. The pet fence according to claim 2, wherein
each of the first fence panels and the second fence panels is a mesh panel.
